(19) United States
(12) Patent Application Publication
(10) Pub. No.: US 2009/0052888 A1
(43) Pub. Date: Feb. 26, 2009

(54) KEY MODULE AND PORTABLE ELECTRONIC DEVICE USING THE SAME

(75) Inventor: WEI-LUNG LEE, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/964,797

(22) Filed: Dec. 27, 2007

(30) Foreign Application Priority Data
Aug. 21, 2007 (CN) 200710201422.5

(51) Int. Cl. G03B 17/00; H04N 5/225

(52) U.S. Cl. 396/543; 348/374; 348/E05.024

(57) ABSTRACT

A key module (10) comprises a cover (12), a receiving socket (14), a camera trigger (17) and a focus trigger (18). The receiving socket has a receiving cavity (142) defined therein. The cover is configured for slidably received in the receiving cavity, and includes a first contact portion (124) and a second contact portion formed on a surface (122) thereof. The first contact portion and the second contact portion trigger the camera trigger and the focus trigger, when the cover is pressed. A portable electronic device using the key module is also disclosed.

### BACKGROUND OF THE INVENTION

1. Field of the Invention

The present invention relates to key modules, particularly to a key module cooperating with a camera module and a portable electronic device using the same.

2. Discussion of the Related Art

With the development of wireless communication and information processing technology, portable electronic devices, such as mobile telephones and personal digital assistants (PDAs), are now in widespread use. Digital camera modules are now widely available as a special feature for portable electronic devices; consequently the integration of digital camera modules and portable electronic devices has become an important part of mobile multimedia technology. As a result of that, optical performance of camera modules in the portable electronic devices is continuously improved. Nowadays, a fixed focus camera with no focusing system of any kind cannot satisfy the requirement of passionate and demanding photographers. Consequentially, a camera module with an optical focusing function appears, as the times require.

Usually, a typical camera module used in a portable electronic device with an optical focus function includes a focus trigger and a capturing trigger. The focus trigger is connected with a focus key. The focus trigger is activated when the focus key is pressed, so that the camera module is in a focused mode. The capturing trigger is connected with a capturing key. The capturing trigger is activated when the capturing key is pressed, and the camera module captures an image. As described above, when using the portable electronic device to photograph, both keys need to be pressed, therefore, creates an inconvenience for the users.

Therefore, a key module cooperating with a camera module and a portable electronic device using the same are desired in order to overcome the above-described problems.

### SUMMARY

In one aspect thereof, a key module comprises a cover, a receiving socket, a camera trigger and a focus trigger. The receiving socket has a receiving cavity defined therein. The cover is configured for slidably received in the receiving cavity, and includes a first contact portion and a second contact portion formed on a surface thereof. The first contact portion and the second contact portion trigger the camera trigger and the focus trigger, when the cover is pressed.

In another aspect thereof, a portable electronic device comprises a housing and a key module provided in the housing. The key module comprises a receiving socket, a cover, a camera trigger and a focus trigger. The receiving socket has a receiving cavity defined therein. The cover is configured for being slidably received in the receiving cavity, and with a first contact portion and a second contact portion formed on a surface thereof. The first contact portion and the second contact portion trigger the camera trigger and the focus trigger, when the cover is pressed.

Other advantages and novel features of the embodiments will become more apparent from the following detailed description thereof when taken in conjunction with the accompanying drawings.

### BRIEF DESCRIPTION OF THE DRAWINGS

Many aspects of the a key module and a portable electronic device using the same can be better understood with reference to the following drawings. The components in the drawings are not necessarily to scale, the emphasis instead being placed upon clearly illustrating the principles of the present key module and the portable electronic device using the same. Moreover, in the drawings, like reference numerals designate corresponding parts throughout the several views, wherein:

FIG. 1 is an assembled, isometric view of a portable electronic device using a key module, in accordance with a present embodiment;

FIG. 2 is a partially disassembled perspective view of the portable electronic device shown in FIG. 1;

FIG. 3 is similar to FIG. 2, but viewed from another aspect;

FIG. 4 is a partially, enlarged view of the portable electronic device shown in FIG. 1; and

FIG. 5 is a partially, cut-away view of the portable electronic device shown in FIG. 4.

### DETAILED DESCRIPTION OF THE PREFERRED EMBODIMENT

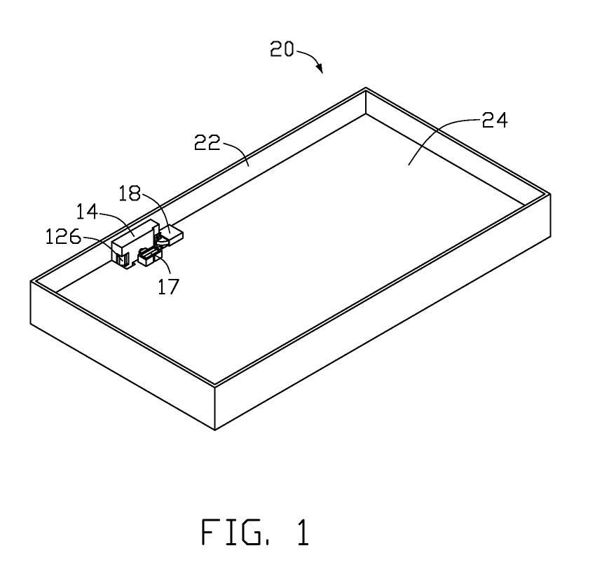

Referring to FIGS. 1 to 3, the present portable electronic device 20 is suitable for a mobile phone, a digital camera, and so on.

The portable electronic device 20 includes a key module 10, a housing 22 and a circuit board 24. The key module 10 is attached to the housing 22. The housing 22 is a rectangular case with an open end. The housing 22 includes a bottom board (not shown) and a sidewall 222 connected to the bottom board. The circuit board 24 is provided on the bottom board contacting with the sidewall 222.

The key module 10 includes a cover 12, a receiving socket 14, an elastic member 16, a camera trigger 17 and a focus trigger 18.

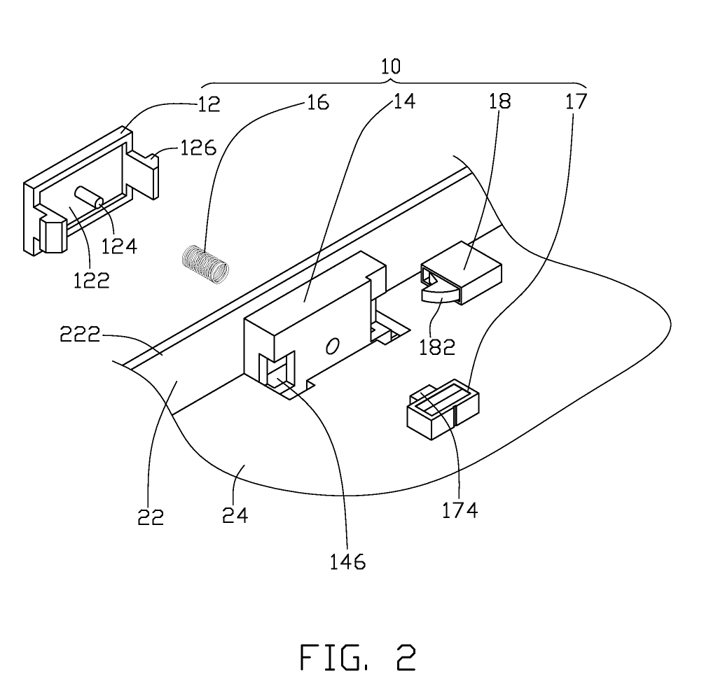

Particularly referring to FIG. 2, the cover 12 is made of a rectangular board. The cover 12 includes an inner surface 122. A first contact portion 124 is formed on a center of the inner surface 122. The first contact portion 124 is a columnar post. Two latching clasps 126 extend from both ends of the inner surface 122. The two latching clasps 126 are symmetrically arranged relative to the first contact portion 124. One of the latching clasps 126 is provided for being a second contact portion of the focus trigger 18.

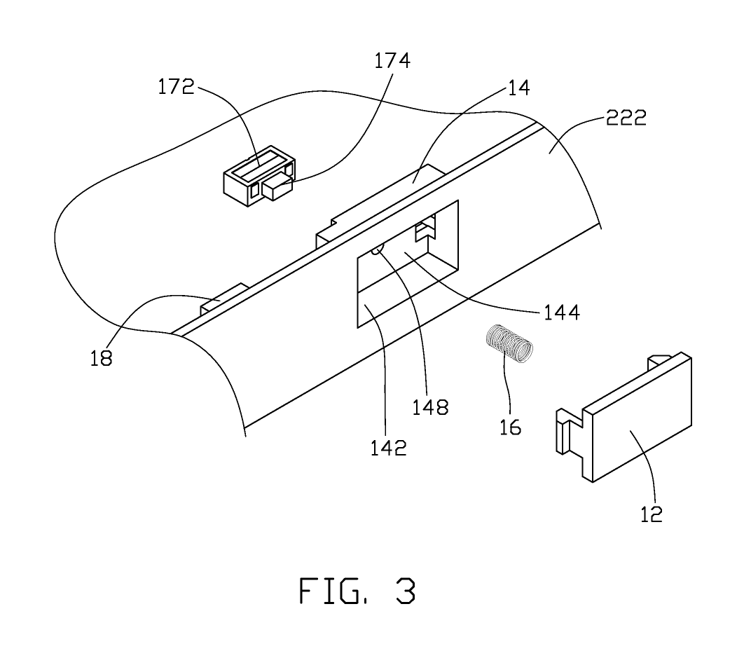

Also referring to FIG. 3, the receiving socket 14 is formed on the housing 22. The receiving socket 14 includes a receiving cavity 142. The cover 12 is configured for being slidably received in the receiving cavity 142. The receiving socket 14 is attached to the side wall 222 of the housing 22, and the cavity 142 thereof reveals to outside. The receiving socket 14 has a base wall 144 parallel to the sidewall 222. Two latching slots 146 are defined in the base wall 144 and the adjacent sidewalls of the receiving socket 14. The two latching slots 146 are provided for cooperating with the two latching clasps 126, to secure the cover 12 with the receiving socket 14. A through hole 148 is defined in the center of the base wall 144. The through hole 148 is provided for the first contact portion 124 passing therethrough.

The elastic member 16 can be a compression spring or a cylindrical elastic sponge. The elastic member 16 is provided between the cover 12 and the receiving socket 14, and is coiled around the first contact portion 124. One end of the elastic member 16 resists the inner surface 122 of the cover 12, and the other end resists the base wall 144 of the receiving socket 14. The elastic member 16 is so structured and arranged that it is operative to be biased between the cover 12 and the receiving socket 14.

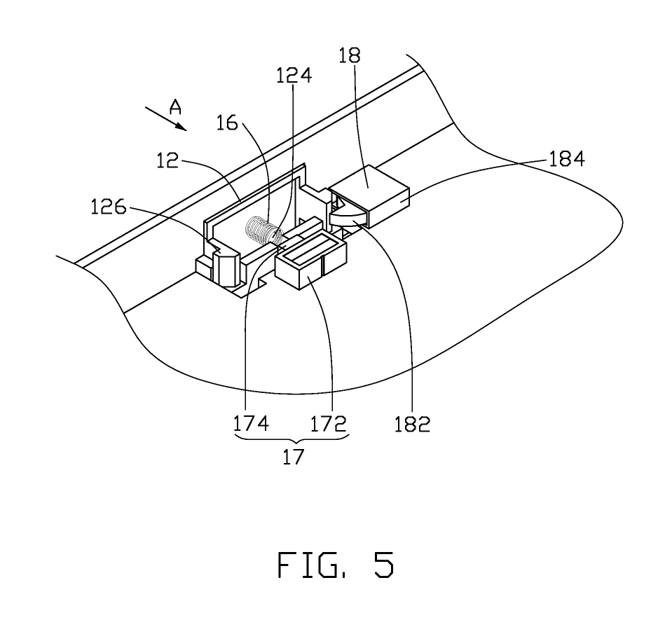

Referring to FIG. 5, the camera trigger 17 includes a main body 172 and a shutter 174 provided in the main body 172. The main body 172 is provided on the circuit board 24. The shutter 174 is provided adjacent the base wall 144 of the receiving cavity 142, and corresponds to (specifically, in line with) the through hole 148. The camera trigger 17 is electronically connected with a circuit controlling the camera module (not shown) used in the portable electronic device 20. The camera trigger 17 is provided for activating the camera module when the shutter 174 thereof is pressed.

The focus trigger 18 includes a focus switch 182 and a box 184 with an open end. The focus switch 182 is provided with an arc-shaped edge. The focus switch 182 is partially and rotatably received in the box 184. The box 184 is provided on the circuit board 24. The focus switch 182 is configured for resisting the latching clasp 126 which functions as the second contact portion.

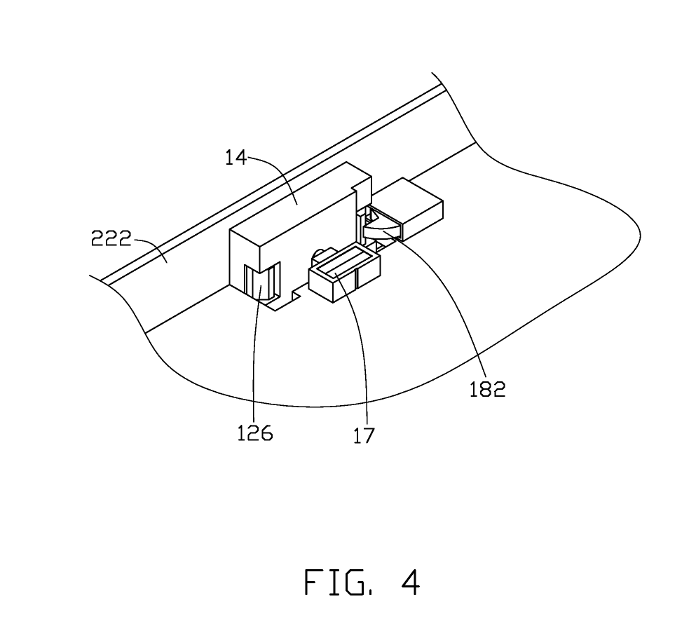

Referring to FIG. 4 and FIG. 5, in assembly, the elastic member 16 is installed to coil over the first contact portion 124 of the cover 12. The cover 12 together with the elastic member 16 is received in the receiving cavity 142 of the receiving socket 14. The elastic member 16 is provided between the inner surface 122 of the cover 12 and the base wall 144 of the receiving socket 14. Each latching clasp 126 in the cover 12 slidably cooperates with a corresponding latching slot 146 of the receiving socket 14. The main body 172 of the camera trigger 17 is provided and fixed on the circuit board 24. The shutter 174 faces the through hole 148 defined in the base wall 144 of the receiving socket 14. The box 184 of the focus trigger 18 is provided and fixed on the circuit board 24, and the focus switch 182 contacts with latching clasp 126 which works as the second contact portion.

In a normal state, the cover 12 is received in the receiving socket 14. The elastic member 16 is compressed. The elastic member 16 is biased between the cover 12 and the base wall 144 of the receiving socket 14. The two latching slots 146 cooperate with the two latching clasps 126 to secure the cover 12 with the receiving socket 14. The focus switch 182 resists the latching clasp 126 which functions as the second contact portion. The shutter 174 and the first contact portion 124 are respectively provided in two opposite sides of the base wall 144 of the receiving socket 142. The shutter 174 and the first contact portion 124 are in line with the through hole 148 and remains in a proximate distance from each other when the cover 12 is not pressed.

In use, the cover 12 is pressed along the direction A shown in FIG. 5, the latching clasp 126 functioning as the second contact portion resists the focus switch 182 to make the focus switch 182 rotate relative to the box 184, so as to activate an auto-focus function of the camera module of the portable electronic device 20. Therefore, the camera module is in a focused mode. Meanwhile, the cover 12 is further pressed along the same direction A, thereby moving the first contact portion 124 to pass through the through hole 148 and resists the shutter 174, so that an image is captured. After capturing the image, the cover 12 is released and returns back to the original position (normal state) due to the biased energy provided by the elastic member 16.

It should be understood, the receiving socket 14 can be a single unit instead of being formed in the housing 22. The single receiving socket 14 can be fixed in the housing 22 by ultrasonic bonding, sweating/soldering, or glue. Additionally, before the cover 12 is pressed down, the focus switch 182 may not necessarily resist the second contact portion 126. It can be only ensured that, the latching clasp 126 functioning as the second contact portion resists and slides over the focus switch 182 firstly when the keypad cover 12 is initially pressed along direction A shown in FIG. 5, and then the first contact portion 124 resists the shutter 174, after the keypad cover 12 is kept pressed along the same direction A.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A key module, comprising:
a receiving socket including a receiving cavity defined therein;
a cover configured for being slidably received in the receiving cavity, and including a first contact portion and a second contact portion formed on a surface thereof,;
a camera trigger; and
a focus trigger;
wherein the first contact portion and the second contact portion trigger the camera trigger and the focus trigger, when the cover is pressed.

2. The key module as claimed in claim 1, wherein the first contact portion is formed in a center of the surface of the cover, and the second contact portion is formed at one edge of the surface.

3. The key module as claimed in claim 1, wherein the receiving socket includes a base wall, the first contact portion is a columnar post, the first contact portion and the camera trigger are provided in two sides of the base wall of the receiving socket for cooperating with each other.

4. The key module as claimed in claim 1, wherein the receiving socket includes a base wall which defines a through hole; the camera trigger includes a shutter, the shutter and the first contact portion are in line with the through hole and are provided in two sides of the base wall of the receiving socket.

5. The key module as claimed in claim 1, wherein the second contact portion is a latching clasp, the focus trigger includes a focus switch; the second contact portion resists the focus switch.

6. The key module as claimed in claim 5, wherein two latching clasps extend from both ends of the inner surface, the two latching clasps are symmetrical relative to the first contact portion, one of the latching clasps is provided for being a second contact portion to activate the focus trigger.

7. The key module as claimed in claim 6, wherein the focus trigger includes a focus switch and the second contact portion resists the focus switch.

8. The key module as claimed in claim 6, further comprising two latching slots defined in the receiving socket and cooperating with the two latching clasps.

9. The key module as claimed in claim 1, further comprising an elastic member, wherein the receiving socket has a base wall and one end of the elastic member resists the cover, while the other end of the elastic member resists the base wall of the receiving socket.

10. The key module as claimed in claim 9, wherein the first contact portion is a columnar post protruding from an inner surface of the cover, the elastic member is coiled over the first contact portion and biased between the cover and the base wall of the receiving socket.

11. A portable electronic device, comprising:
a housing; and
a key module provided in the housing, the key module comprising:
a receiving socket including a receiving cavity defined therein;
a cover configured for being slidably received in the receiving cavity, and including a first contact portion and a second contact portion formed on a surface thereof;
a camera trigger; and
a focus trigger;
wherein the first contact portion and the second contact portion trigger the camera trigger and the focus trigger, when the cover is pressed.

12. The portable electronic device module as claimed in claim 11, wherein the first contact portion is formed in a center of the surface of the cover, and the second contact portion is formed at one edge of the surface.

13. The portable electronic device as claimed in claim 11, wherein the housing is a case with an open end, the housing includes a sidewall, and the receiving socket is provided in the sidewall.

14. The portable electronic device as claimed in claim 12, further comprising a circuit board, wherein the camera trigger and the focus trigger are provided on the circuit board.

15. The portable electronic device as claimed in claim 11, wherein the receiving socket includes a base wall, the first contact portion is a columnar post, the first contact portion and the camera trigger are provided in two sides of the base wall of the receiving socket for cooperating with each other.

16. The portable electronic device as claimed in claim 11, wherein the receiving socket includes a base wall which defines a through hole; the camera trigger includes a shutter, the shutter and the first contact portion are in line with the through hole and are provided in two sides of the base wall of the receiving socket.

17. The portable electronic device as claimed in claim 11, wherein the second contact portion is a latching clasp, the focus trigger includes a focus switch; the second contact portion resists the focus switch.

18. The portable electronic device as claimed in claim 17, wherein two latching clasps extend from both ends of the inner surface, the two latching clasps are symmetrical relative to the first contact portion, one of the latching clasps is provided for being a second contact portion to activate the focus trigger.

19. The portable electronic device as claimed in claim 18, wherein the focus trigger includes a focus switch and the second contact portion resists the focus switch.

20. The portable electronic device as claimed in claim 18, further comprising two latching slots defined in the receiving socket and cooperating with the two latching clasps.
